(19) United States
(12) Patent Application Publication
(10) Pub. No.: US 2010/0104182 A1
(43) Pub. Date: Apr. 29, 2010

(54) Restoring and synthesizing glint within digital image eye features

(76) Inventors: Jay S. Gondek, Camas, WA (US); John Mick, Fort Collins, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/528,760

(22) PCT Filed: Feb. 28, 2007
(86) PCT No.: PCT/US07/05396

§ 371 Date: Aug. 26, 2009

(51) Int. Cl. G06K 9/00; G06K 9/40

(52) U.S. Cl. 382/167; 382/274

(57) ABSTRACT

A digital camera device (700) includes an image-capturing mechanism (702) and a controller (704). The image-capturing mechanism captures a digital image having one or more eye features. The controller at least determines whether each eye feature is to have glint restored or synthesized, and in response restores or synthesizes the glint within the eye feature.

### BACKGROUND

Digital cameras are popular devices by which users can take pictures, yielding digital images. As with more traditional film-based cameras, pictures of people and animals, like pets, that are taken using a flash (a momentary burst of bright light intended to illuminate the scene) can be problematic. In particular, human subjects can exhibit “red eye,” in which the flash is reflected from the backs of their eyes, off their retinas, resulting in their eyes appearing red within the digital images. Likewise, animal subjects can exhibit “pet eye,” in which the flash is also reflected from the backs of their eyes, off their retinas, resulting in their eyes appearing white or an unnatural color within the digital images.

Existing approaches to fixing “red eye” or “pet eye” first segment a digital image to identify the pixels of eye features within the digital image. Thereafter, if the eye features are determined to include “red eye” or “pet eye,” correction is achieved by usually simply darkening the eye features. However, the resulting corrected eye features can appear unnatural. In particular, the natural glint, or specular highlights, resulting from the flash being reflected by the front of the subjects' eyes, as opposed to by the back of their eyes, off their retinas, is typically removed in the correction process as well, giving the corrected eye features their unnatural look.

### BRIEF DESCRIPTION OF THE DRAWINGS

FIG. 1 is a flowchart of a method, according to an embodiment of the invention.

FIGS. 2A and 2B are diagrams of an example digital image having eye features in which glint has been restored, according to an embodiment of the invention.

FIGS. 3A and 3B are diagrams of an example digital image having eye features in which glint has been synthesized, according to an embodiment of the invention.

FIG. 4 is a flowchart of a method for determining whether an eye feature of a digital image has restorable glint, according to an embodiment of the invention.

FIG. 5 is a flowchart of a method for restoring glint within an eye feature of a digital image, according to an embodiment of the invention.

FIG. 6 is a flowchart of a method for synthesizing, or adding, glint to an eye feature of a digital image, according to an embodiment of the invention.

FIG. 7 is a rudimentary block diagram of a digital camera device, according to an embodiment of the invention.

### DETAILED DESCRIPTION OF THE DRAWINGS

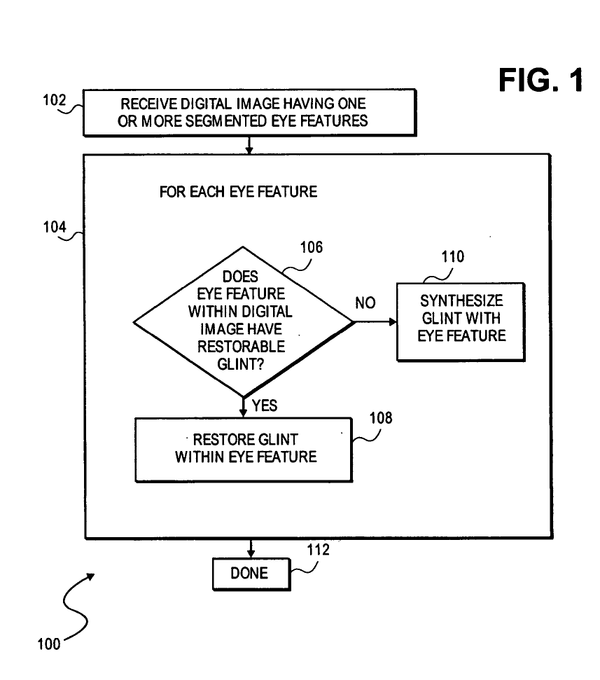

FIG. 1 shows a method 100, according to an embodiment of the invention. The method 100 may be performed by a digital camera device, a computing device, or another type of electronic device having computational capabilities. A digital image having one or more segmented eye features is received (102). The digital image may be that which was taken with a digital camera, for instance. As another example, the digital image may be that which was taken with a conventional film-based camera, and the resulting hardcopy print scanned in to yield the digital image. In general, the digital image includes one or more subjects that have eyes, such as people, animals like pets, and so on. Each eye of each subject is referred to herein as an eye feature.

The eye features have been segmented within the digital image in that the identification of each eye feature within the digital image has been specified as part of the receipt of the digital image. For example, the eye features may each be identified by a set of pixels within a bounding rectangle, with starting x and y coordinates indicating the upper left-hand position of the rectangle relative to the digital image itself, and height and width values indicating how high and wide, respectively, the rectangle is. The eye features may be identified in other ways, however, and do not have to be identified by rectangles. For example, a binary map, identifying the pixels of the eye features, may be provided with the bounding rectangle to distinguish the pixels of the eye features from other pixels within the rectangle. Such eye feature segmentation can be achieved as is accomplished conventionally, or in another way.

For each eye feature within the digital image, the following is performed (104). First, it is determined whether the eye feature has restorable glint (106). Glint is a specular highlight that results from a flash (a momentary burst of bright light intended to illuminate a scene) being employed when taking a picture, where the flash substantially reflects off the surface of a subject's eyes. Glint is a natural feature of light reflecting off an eye's surface, and is desirable to include or retain within the digital image. By comparison, the reflection of the flash from the backs of subjects' eyes—off their retinas—results in undesired “red eye” in human subjects and “pet eye” in animal subjects. As noted in the background, conventional correction of red eye and pet eye generally involves darkening the eye features within a digital image, which also undesirably removes the glint from each eye feature.

Restorable glint is glint that is present within the eye feature of the digital image, but which may be hidden due to the surrounding red eye or pet eye. Therefore, if the eye feature does have such restorable glint (106), then the glint is restored within the eye feature (108). That is, the eye feature of the digital image is digitally manipulated to restore the glint, while removing the surrounding red eye or pet eye. However, in some situations, the glint may be so overpowered by the surrounding red eye or pet eye within the eye feature, or it may be absent, such that the glint cannot be restored. Therefore, if the eye feature does not have restorable glint (106), then the glint is instead synthesized within the eye feature (110). That is, artificial but natural-looking glint is added to the eye feature of the digital image, while removing the red eye or pet eye. Once all the eye features of the digital image have been processed, the method 100 is finished (112).

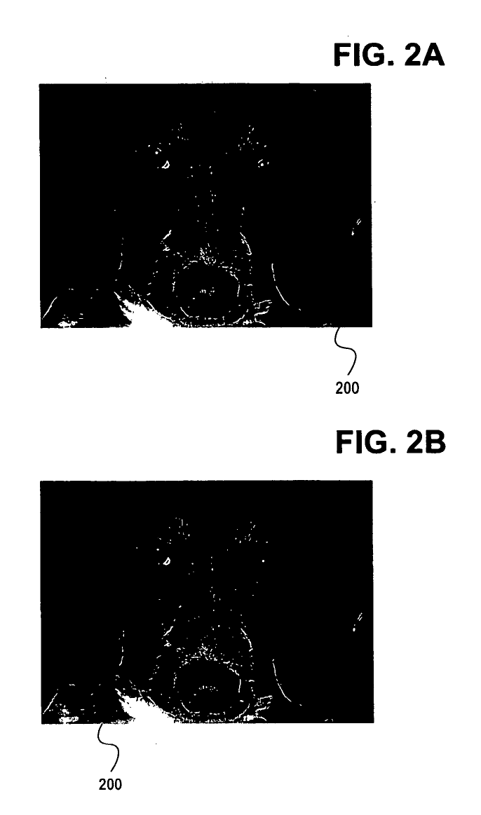

FIGS. 2A and 2B show an example digital image 200 in which glint has been restored within the eye features of the digital image 200, according to an embodiment of the invention. In FIG. 2A, the original digital image 200 includes eye features that suffer from pet eye. However, the eye features do include restorable glint. In FIG. 2B, the eye features of the digital image 200 have been digitally manipulated to restore the glint, while removing the pet eye.

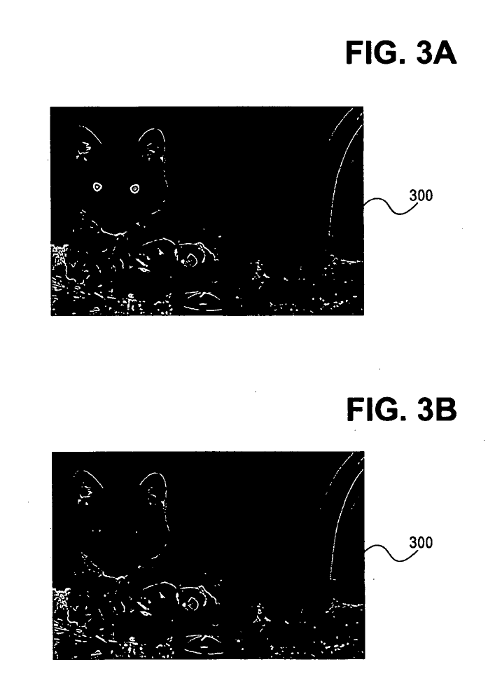

FIGS. 3A and 3B show an example digital image 300 in which glint has been synthesized within the eye features of the digital image 300, according to an embodiment of the invention. In FIG. 3A, the original digital image 300 includes eye features that suffer from pet eye. Furthermore, the eye features do not include any restorable glint. In FIG. 3B, the eye features of the digital image 300 have been digitally manipulated to synthesize glint, while removing the pet eye.

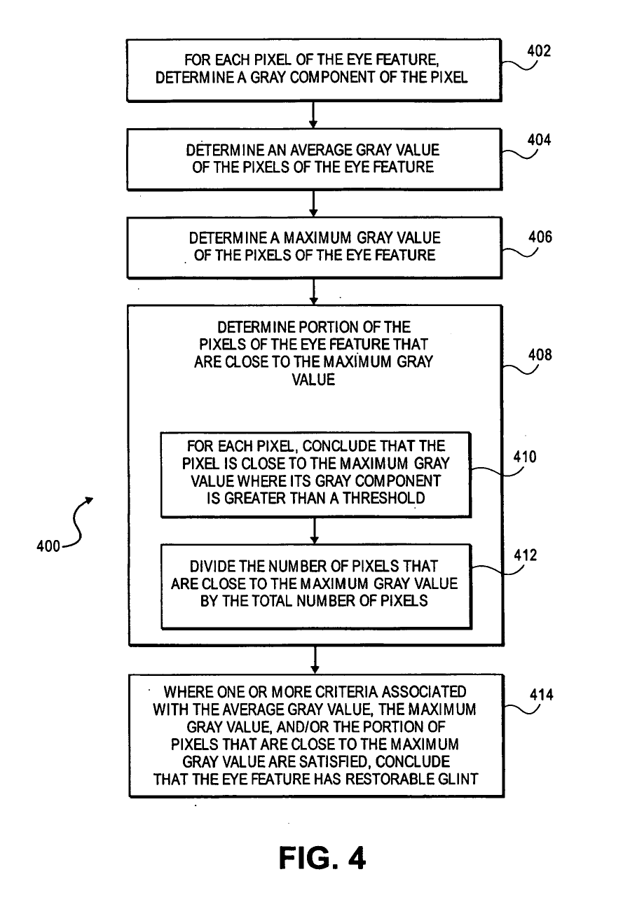

FIG. 4 shows a method 400 for determining whether an eye feature of a digital image has restorable glint, according to an embodiment of the invention. The method 400 can be performed to implement part 106 of the method 100 of FIG. 1, for instance. In general, the method 400 operates by comparing each pixel of the eye feature to a neutral component of the color components of the pixel, such as the red, green, and blue color components of the pixel. This is now described in detail.

First, for each pixel of the eye feature, a gray component of the pixel is determined (402). In one embodiment, the gray component is the minimum value of the color components of the pixel. For example, a pixel may have a red color component value of R, a green color component value of G, and a blue color component value of B, which those of ordinary skill within the art recognize as together defining the color of the pixel. The gray component of the pixel is thus the smallest value among the values R, G, and B, in this embodiment of the invention.

An average gray value of the pixels of the eye feature is then determined (404). The average gray value is determined as the average of the gray components of all the pixels of the eye feature. Next, a maximum gray value of the pixels of the eye feature is determined (406). The maximum gray value is determined as the maximum gray component among the gray components of all the pixels of the eye feature. For example, if a given pixel has a gray component X that is greater than the gray component of any other pixel, then the maximum gray value is X.

Thereafter, a portion of the pixels of the eye feature that are close to the maximum gray value is determined (408). In one embodiment, this is achieved by performing parts 410 and 412. Thus, for each pixel, it is concluded that the pixel is close to the maximum gray value where the gray component of the pixel is greater than a first threshold (410). In one embodiment, this first threshold may be equal to

$$\frac{( AVG + MAX )}{2} ,$$

where AVG is the average gray value that has been determined, and MAX is the maximum gray value that has been determined. The number of pixels that are close to the maximum gray value in this way is divided by the total number of pixels of the eye feature (412), to yield the portion of the pixels of the eye feature that are close to the maximum gray value.

Finally, where one or more criteria associated with the average gray value, the maximum gray value, and/or the portion of the eye feature pixels that are close to the maximum gray value are satisfied, it is conclude that the eye feature has restorable glint (414). In one embodiment, there are three specific criteria, all of which have to be satisfied to conclude that the eye feature has restorable glint. The first criterion is whether the average gray value is less than a second threshold. The second threshold may be 170 where the gray component is eight bits in length, and thus can have a value between 0 and 255. The second criterion is whether the maximum gray value is greater than a third threshold, which may be 200 where the gray component is eight bits in length. The third criterion is whether the portion of the eye feature pixels that are close to the maximum gray value is less than a fourth threshold and greater than a fifth threshold. The fourth and fifth thresholds may be fifteen and one percent, respectively.

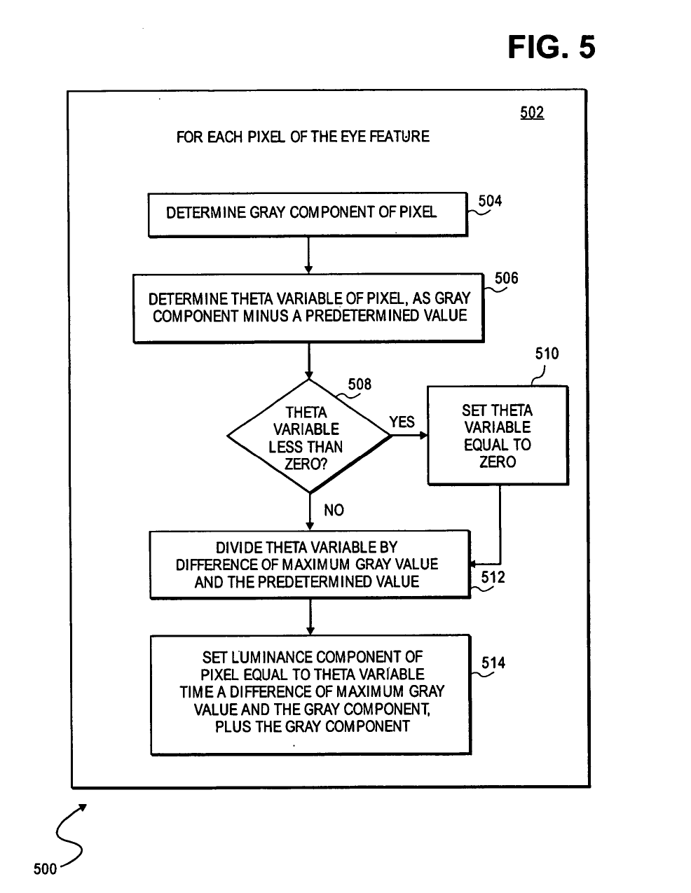

FIG. 5 shows a method 500 for restoring glint within an eye feature of a digital image, according to an embodiment of the invention. The method 500 can be performed to implement part 108 of the method 100 of FIG. 1, for instance. In general, the method 500 operates by scaling the luminance component of each pixel of the eye feature relative to a gray component of the pixel. As such, pixels of the eye feature at the maximum gray value that has been determined in part 406 of the method 400 of FIG. 4 have their luminance component set to white, pixels of the eye feature at or lower than a predetermined value have their luminance component set to black, and pixels having gray components between these two values have their luminance component scaled between white and black. Thus, glint is restored, while removing red eye and pet eye.

The predetermined value in question can be a parameterized value that is based on what percentage of the eye feature is expected to go to black to remove red eye or pet eye. In one embodiment, this value may be 70%, where the luminance component of a pixel can range from 0 to 100%. Furthermore, as has been noted above, a pixel can have its color described by values for a number of color components, such as red, green, and blue color components. A pixel can also have its color described by values for a luminance component and one or more chrominance components, as can be appreciated by those of ordinary skill within the art. The method 500 changes the color of a pixel by changing its luminance component, as is now described in detail.

The method 500 is performed for each pixel of the eye feature (502). First, a gray component of the pixel is determined (504), as the minimum value of the color components of the pixel, as has been described in relation to part 402 of the method 400 of FIG. 4. A theta variable for the pixel, which is not to be confused with the luminance component of the pixel, is determined as this gray component minus the predetermined value that has been described in the previous paragraph (506). If the theta variable is less than zero (508), it is set equal to zero.

Thereafter, the theta variable is divided by the difference of the maximum gray value and the predetermined value that has been described (512). That is,

$$THETA = \frac{THETA}{( MAX - PRE )} ,$$

where THETA is the theta variable, MAX is the maximum gray value determined in part 402 of the method 400 of FIG. 4, and PRE is the predetermined variable. Finally, the luminance component of the pixel is set equal to the theta variable, times a difference of the maximum gray value and the gray component, plus the gray component (514). That is, LUMACOMP=(THETA*(MAX−GRAY))+GRAY, where LUMACOMP is the luminance component of the pixel, THETA is the theta variable, MAX is the maximum gray value determined part 402 of the method 400, and GRAY is the gray component of the pixel.

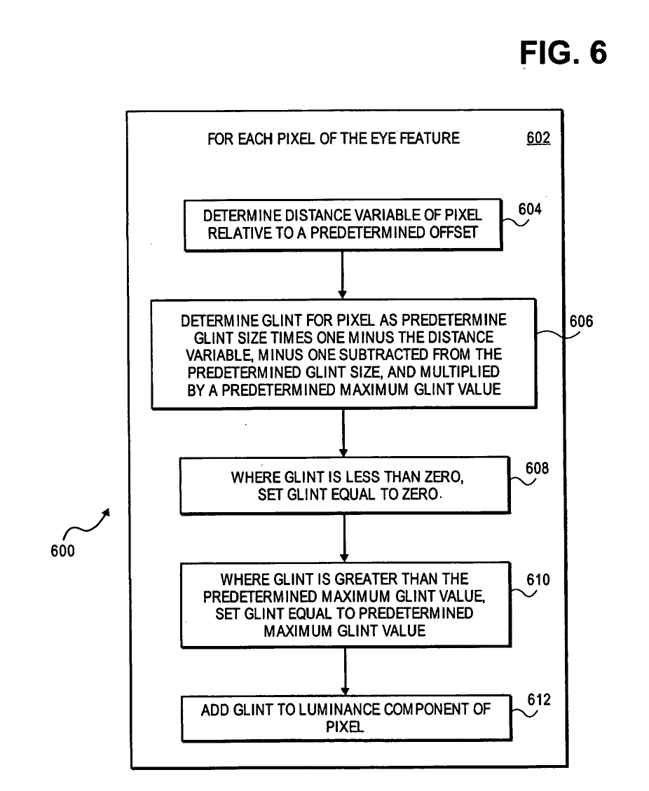

FIG. 6 shows a method 600 for synthesizing glint within an eye feature of a digital image, according to an embodiment of the invention. The method 600 can be performed to implement part 110 of the method 100 of FIG. 1, for instance. In general, the method 600 operates by adding glint to a luminance component of each pixel of the eye feature that is located within a predefined area of the eye feature. The predefined area may be a predetermined offset from the center of the eye feature, for instance. The size of the area may be a minimum size, such as three pixels in diameter, plus the radius of the eye feature itself divided by another predetermined value, such as sixteen. In this way, glint is synthesized, while removing red eye and pet eye.

The method 600 is performed for each pixel of the eye feature (602). First, a distance variable of the pixel, relative to a predetermined offset, is determined (604). In one embodiment, this distance variable is determined as a square root of the square of a normalized y location of the pixel minus a y location of the predetermined offset, plus a square of a normalized x location of the pixel minus an x location of the predetermined offset. That is, DIST=\sqrt{(YNORM−YOFF)²+(XNORM−XOFF)²}, where DIST is the distance variable, YNORM is the normalized y location of the pixel within the eye feature, XNORM is the normalized x location of the pixel within the eye feature, YOFF is the y location of the predetermined offset, and XOFF is the x location of the predetermined offset.

The normalized y location of the pixel is the y coordinate of the pixel within the eye feature normalized in one embodiment as follows:

$$\frac{2 Y}{HEIGHT} - 1.$$

Y is the y coordinate of the pixel within the eye feature, where Y=0 denotes the uppermost row of the eye feature. HEIGHT is the height of the eye feature in pixels. Likewise, the normalized x location of the pixel is the x coordinate of the pixel within the eye feature normalized in one embodiment as follows:

$$\frac{2 X}{WIDTH} - 1.$$

X is the x coordinate of the pixel within the eye feature, where X=0 denotes the leftmost column of the eye feature. WIDTH is the height of the eye feature in pixels. The distance variable is thus a normalized value between negative one and one.

Next, the glint to be added to the pixel is determined as a predetermined glint size times one minus the distance variable, minus one subtracted from the predetermined glint size, and multiplied by a predetermined maximum glint value (606). That is, GLINT=(GSIZE*(1−DIST)−(GSIZE−1))*GMAX. GLINT is the glint to be added to the pixel. GSIZE is the predetermined glint size ratio, which in one embodiment may be three, or another constant, plus a radius of the eye feature divided by sixteen, or another constant. Thus, glint size on an absolute basis scales up with eye size, so that there is larger glint in eye features of just a few pixels so that it can be seen by the user; however, in relation to the size of the eye feature itself, glint size scales down. DIST is the distance variable that has been determined. GMAX is the predetermined maximum glint value. GMAX in one embodiment may be equal to 120%, or another constant, of the maximum gray value within the eye feature determined in part 406 of the method 400 of FIG. 4, but no less than 85%, or another constant, of the white value any pixel within the eye feature can take on. For example, where the pixels within the eye feature are each eight bits in length, the white value of any pixel is equal to 255, such that GMAX cannot be lower than 85% of 255.

Once the glint for the pixel has been determined, if the glint is less than zero, then the glint is set equal to zero (608). Similarly, where the glint is greater than the predetermined maximum glint value, then it is set equal to the maximum glint value (610). Finally, the glint is added to the luminance component of the pixel (612). That is, LUMACOMP=LUMACOMP+GLINT, where LUMACOMP is the luminance component of the pixel, which may be the minimum color that is used to recolor the eye feature, and which may be zero in one embodiment, and GLINT is the glint that has been determined.

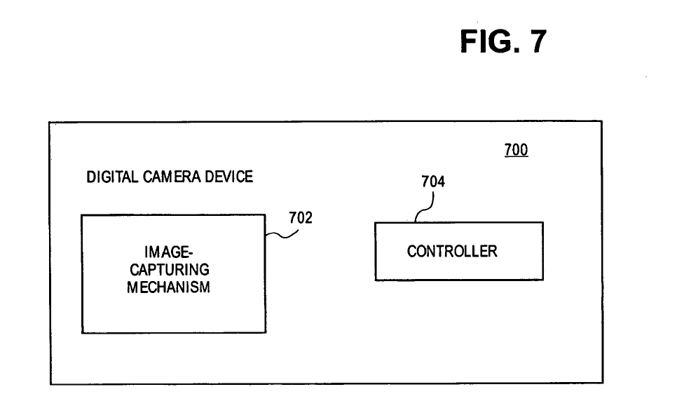

FIG. 7 shows a rudimentary block diagram of a digital camera device 700, according to an embodiment of the invention. The digital camera device 700 includes at least an image-capturing mechanism 702 and a controller 704. As those of ordinary skill within the art can appreciate, the digital camera device 700 can and typically will include other components, in addition to those shown in FIG. 7.

The image-capturing mechanism 702 captures a digital image in which there are one or more eye features. That is, the mechanism 702 takes a digital photo of one or more subjects, such as human subjects and animal subjects like pets, that have eye features inflicted with red eye and/or pet eye. The image-capturing mechanism 702 may be a charge-coupled device (CCD) sensor, a complementary metal-oxide semiconductor (CMOS) sensor, or another type of image-capturing mechanism.

The controller 704 is for at least determining whether each eye feature within the digital image captured by the image-capturing mechanism 702 is to have glint restored or synthesized, and in response is to appropriately restore or synthesize the glint within the eye feature. For instance, the controller 704 may perform the methods 400, 500, and 600 of FIGS. 4, 5, and 6 that have been described. The controller 704 may be implemented in software, hardware, or a combination of software and hardware.

We claim:

1. A method (100) comprising:
determining whether an eye feature of a digital image has restorable glint (106);
in response to determining that the eye feature of the digital image has restorable glint,
restoring glint within the eye feature (108); and,
in response to determining that the eye feature of the digital image does not have restorable glint,
synthesizing the glint within the eye feature (110).

2. The method of claim 1, wherein determining whether the eye feature of the digital image has restorable glint comprises comparing each pixel of a plurality of pixels of the eye feature relative to a neutral component of a plurality of color components of the pixel.

3. The method of claim 1, wherein determining whether the eye feature of the digital image has restorable glint comprises:
for each pixel of a plurality of pixels of the eye feature, determining a gray component of the pixel as a minimum of a plurality of color components of the pixel (402);
determining an average gray value as to the gray components of the pixels of the eye feature (404);
determining a maximum gray value as to the gray components of the pixels of the eye feature (406);
determining a portion of the pixels of the eye feature that are close to the maximum gray value (408); and,
where one or more criteria associated with the average gray value, the maximum gray value, and/or the portion of the pixels that are close to the maximum gray value are satisfied, concluding that that the eye feature has restorable glint (414).

4. The method of claim 3, wherein determining the portion of the pixels of the eye feature that are close to the maximum gray value comprises:
for each pixel of the plurality of pixels of the eye feature, concluding that the pixel is close to the maximum gray value where the pixel has a gray component greater than a first predetermined threshold (410); and,
dividing a number of the pixels that are close to the maximum gray value by a total number of the pixels to yield the portion of the pixels that are close to the maximum gray value (412).

5. The method of claim 4, wherein the first predetermined threshold comprises a sum of the average gray value plus the maximum gray value, divided by two.

6. The method of claim 4, wherein the criteria comprise:
whether the average gray value is less than a second predetermined threshold;
whether the maximum gray value is greater than a third predetermined threshold; and,
whether the portion of the pixels that are close to the maximum gray value is less than a fourth predetermined threshold and greater than a fifth predetermined threshold.

7. The method of claim 1, wherein restoring the glint within the eye feature comprises scaling a luminance component of each pixel of a plurality of pixels of the eye feature relative to a gray component of the pixel.

8. The method of claim 7, wherein scaling the luminance component of each pixel of the eye feature relative to the gray component of the pixel is such that pixels of the eye feature at a maximum gray value are set to white, pixels of the eye feature at or lower than a predetermined value are set to black, and pixels of the eye feature between the predetermined value and the maximum gray value are scaled between white and black.

9. The method of claim 1, wherein restoring the glint within the eye feature comprises, for each pixel of a plurality of pixels of the eye feature:
determining a gray component of the pixel as a minimum of a plurality of color components of the pixel (504);
determining a theta variable equal to the gray component of the pixel minus a predetermined value (506);
where the theta variable is less than zero, setting the theta variable to zero (510);
dividing the theta variable by a difference of a maximum gray value and the predetermined value (512); and,
setting the luminance component of the pixel equal to the theta variable times a difference of the maximum gray value and the gray component, plus the gray component (514).

10. The method of claim 1, wherein synthesizing the glint within the eye feature comprises adding the glint to a luminance component of each pixel of a plurality of pixels of the eye feature that are located within a predefined area of the eye feature.

11. The method of claim 10, wherein the predefined area of the eye feature is offset from a center of the eye feature.

12. The method of claim 1, wherein synthesizing the glint within the eye feature comprises, for each pixel of a plurality of pixels of the eye feature:
determining a distance variable of the pixel relative to a predetermined offset within the eye feature (604);
determining the glint for the pixel as a predetermined glint size times one minus the distance variable, minus one subtracted from the predetermined glint size, and multiplied by a predetermined maximum glint value (606);
where the glint for the pixel is less than zero, setting the glint equal to zero (608);
where the glint for the pixel is greater than the predetermined maximum glint value, setting the glint equal to the predetermined maximum glint value (610); and,
adding the glint to a luminance component of the pixel (612).

13. The method of claim 12, wherein determining the distance variable of the pixel comprises determining a square root of a square of a normalized y location of the pixel minus a y location of the predetermined offset, plus a square of a normalized x location of the pixel minus an x location of the predetermined offset.

14. The method of claim 12, wherein the predetermined glint size is equal to a first constant plus a radius of the eye feature divided by a second constant, and the predetermined maximum glint value is equal to a third constant times a maximum gray value within the eye feature but no less than a predetermined threshold.
